(19) United States
(12) Patent Application Publication
(10) Pub. No.: US 2026/0182641 A1
(43) Pub. Date: Jul. 2, 2026

(54) ATOMIZING CORE, ATOMIZING ASSEMBLY, AND ATOMIZING DEVICE

(71) Applicant: Zhuhai Kihons Technology Co., LTD, Zhuhai (CN)

(72) Inventors: Wenhao FU, Zhuhai (CN); Jikang HUANG, Zhuhai (CN)

(73) Assignee: Zhuhai Kihons Technology Co., LTD, Zhuhai (CN)

(21) Appl. No.: 19/281,529

(22) Filed: Jul. 25, 2025

(30) Foreign Application Priority Data
Dec. 31, 2024 (CN) 202423318055.5
Mar. 28, 2025 (CN) 202520582309.X

(51) Int. Cl. A24F 40/46; A24F 40/10; A24F 40/44; H05B 3/20

(52) U.S. Cl. CPC A24F 40/46; A24F 40/10; A24F 40/44; H05B 3/20; H05B 2203/007; H05B 2203/021; H05B 2203/037

(57) ABSTRACT

An atomizing core, an atomizing assembly, and an atomizing device are provided. The atomizing core includes a heating member and a first liquid-guiding element. The heating member includes a heating portion. The heating portion includes a first heating element, a connecting element, and a second heating element that are connected sequentially, and the first heating element and the second heating element are disposed opposite to each other and spaced apart. The first liquid-guiding element is disposed between the first heating element and the second heating element and configured to adsorb and transport aerosol-generating matrix. Both the atomizing assembly and the atomizing device include the atomizing core.

### CROSS-REFERENCE TO RELATED APPLICATIONS

This application claims priority to and the benefits of Chinese Patent Application No. 2024233180555 filed on Dec. 31, 2024, and Chinese Patent Application No. 202520582309X filed on Mar. 28, 2025, the disclosures of which are incorporated herein by reference in their entireties.

### TECHNICAL FIELD

The present disclosure relates to the field of atomizing technologies, and in particular, to an atomizing core, an atomizing assembly, and an atomizing device.

### BACKGROUND

An atomizing device can heat aerosol-generating matrix to generate aerosol. An atomizing core is a key member of the atomizing device and includes a heating element and a liquid-guiding element. The liquid-guiding element is configured to transport the aerosol-generating matrix, while the heating element is capable of generating heat when energized, thereby realizing the heating of the aerosol-generating matrix in the liquid-guiding element.

In the related art, the heating element adopts a single-layer structure, which may cause an area of the heating element corresponding to the liquid-guiding element to be prone to damage at high temperatures. This, in turn, leads to the occurrence of core charring, affecting the taste of the atomizing product. Additionally, carbonized products generated by the high-temperature damage of the liquid-guiding element may adhere to the surface of the heating element, reducing the heating efficiency of the heating element and thus affecting the user experience of the atomizing core.

### SUMMARY

Some embodiments of the present disclosure provide an atomizing core that includes a heating member and a first liquid-guiding element. The heating member includes a heating portion. The heating portion includes a first heating element, a first connecting element, and a second heating element connected sequentially, and the first heating element and the second heating element are disposed opposite to each other and spaced apart. The first liquid-guiding element is disposed between the first heating element and the second heating element and configured to adsorb and transport aerosol-generating matrix.

Some embodiments of the present disclosure provide an atomizing assembly including the above-mentioned atomizing core and a base disposed at a bottom of the atomizing core.

Some embodiments of the present disclosure further provide an atomizing device including the above-mentioned atomizing core and a power supply module, and the power supply module is electrically connected to the atomizing core.

### BRIEF DESCRIPTION OF THE DRAWINGS

In order to explain technical solutions in embodiments of the present disclosure more clearly, the following will briefly introduce the drawings needed to be used in description of the embodiments or the prior art. Apparently, the drawings in the following description are only some embodiments of the present disclosure. For ordinary skilled in the art, other drawings can be obtained from these drawings without paying creative effort.

FIG. 1 is a schematic diagram of a first structure of an atomizing core at a first viewing angle according to some embodiments of the present disclosure.

FIG. 2 is a schematic diagram of the first structure of the atomizing core at a second viewing angle according to some embodiments of the present disclosure.

FIG. 3 is a schematic diagram of a structure of a heating member shown in FIG. 2.

FIG. 4 is a schematic top view of the heating member shown in FIG. 2.

FIG. 5 is a schematic axial cross-sectional diagram of the atomizing core shown in FIG. 2.

FIG. 6 is a schematic diagram of a second structure of the atomizing core according to some embodiments of the present disclosure.

FIG. 7 is a schematic diagram of a structure of a fixing element shown in FIG. 6.

FIG. 8 is a schematic diagram of a third structure of the atomizing core according to some embodiments of the present disclosure.

FIG. 9 is a schematic diagram of a structure of a fixing element shown FIG. 8.

FIG. 10 is a schematic diagram of a fourth structure of the atomizing core according to some embodiments of the present disclosure.

FIG. 11 is a schematic axial cross-sectional diagram of the atomizing core shown in FIG. 10.

FIG. 12 is a schematic diagram of a fifth structure of the atomizing core at a first viewing angle according to some embodiments of the present disclosure.

FIG. 13 is a schematic diagram of the fifth structure of the atomizing core at a second viewing angle according to some embodiments of the present disclosure.

FIG. 14 is a schematic cross-sectional diagram of the atomizing core shown in FIG. 13.

FIG. 15 is a schematic top view of the atomizing core shown in FIG. 13.

FIG. 16 is a schematic diagram of a first structure of a heating member shown in FIG. 13.

FIG. 17 is a schematic diagram of a second structure of the heating member shown in FIG. 13.

FIG. 18 is a schematic diagram of a structure of an atomizing assembly at a first viewing angle according to some embodiments of the present disclosure.

FIG. 19 is a schematic diagram of the structure of the atomizing assembly at a second viewing angle according to some embodiments of the present disclosure.

FIG. 20 is a schematic diagram of the structure of the atomizing assembly at a third viewing angle according to some embodiments of the present disclosure.

FIG. 21 is a schematic top view of the atomizing assembly shown in FIG. 18.

Reference numerals: 200, atomizing assembly; 100, atomizing core; 10, heating member; 20, first liquid-guiding element; 30, atomizing bracket; 301, gap; 40, second liquid-guiding element; 50, fixing element; 60, base; 1, heating portion; 11, first heating element; 111, first end; 112, second end; 113, first mesh hole; 12, first connecting element; 13, second heating element; 131, third end; 132, fourth end; 133, second mesh hole; 14, second connecting element; 2, pin; 21, first conductive pin; 22, second conductive pin; 31, positioning strip; and 32, opening.

### DETAILED DESCRIPTION

In order to make the technical problems, technical solutions and beneficial effects to be solved by the present disclosure more clearly understood, the following provides a further detailed explanation of present disclosure in conjunction with the attached drawings and embodiments. It should be understood that the specific embodiments described here are merely for explaining the present disclosure and are not intended to limit the present disclosure.

It should be noted that when an element is referred to as “fixed to” or “disposed at/on” another element, it can be directly on the other element or indirectly on the other element. When an element is referred to as being “connected to” another element, it can be directly connected to the other element or indirectly connected to the other element.

In the description of the present disclosure, it should be understood that, directional or positional relationships indicated by the terms “center”, “longitudinal”, “transverse”, “length”, “width”, “thickness”, “top”, “bottom”, “front”, “back”, “left”, “right”, “vertical”, “horizontal”, “topmost”, “bottommost”, “inner”, “outer”, “clockwise”, “counterclockwise”, “axial”, “radial”, “circumferential”, and the like, are based on the directional or positional relationships shown in the drawings, which are used only for the convenience of describing the present disclosure and simplifying the description, rather than indicating or implying that a device or an element must have a specific direction, be constructed or operated in a specific direction. Therefore, the terms should not be interpreted as limitations on the present disclosure.

Moreover, the terms “first” and “second” are used merely for descriptive purposes and should not be construed to indicate or imply relative importance or to implicitly specify the quantity of the technical features indicated. Therefore, the features limited by “first” and “second” may explicitly or implicitly include one or more features. In the description of the present disclosure, the term “a plurality of” refers to two or more than two, unless otherwise specified.

In the description of the present disclosure, unless otherwise explicitly specified and defined, terms such as “install”, “mount”, “connect”, and “fix” shall be interpreted broadly. For example, they may refer to a fixed connection, a detachable connection, or an integral connection. Alternatively, they may refer to a mechanical connection, an electrical connection, or a communicative connection. Alternatively, they may be refer to a direct connection or an indirect connection through an intermediate medium. Alternatively, they may refer to an internal communication of two elements or an interactive relationship between two elements, unless otherwise explicitly defined. For those skilled in the art, specific meanings of these terms in the present disclosure can be understood based on specific circumstances.

In the present disclosure, unless otherwise explicitly specified and defined, a first feature being “above”, “on”, or “below” the second feature may refer to the first feature and the second feature being in direct contact, or the first feature and the second feature being in indirect contact through an intermediate medium. Further, the first feature being “on”, “above”, or “over” the second feature may mean that the first feature is directly above or obliquely above the second feature, or simply indicates that a horizontal height of the first feature is higher than a horizontal height of the second feature. The first feature being “under”, “below”, or “beneath” the second feature may mean that the first feature is directly below or obliquely below the second feature, or simply indicates that the horizontal height of the first feature is lower than the horizontal height of the second feature.

In the present disclosure, terms such as “an embodiment”, “a specific embodiment”, “some embodiments”, “an example”, “a specific example”, or “some examples” mean that a specific feature, a structure, a material, or a characteristic described in conjunction with the embodiment(s) or example(s) is included in at least one embodiment or example of the present disclosure. In the present disclosure, schematic expressions of the above terms are not directed to the same embodiment or example. Moreover, a specific feature, a structure, a material, or a characteristic described may be combined in any suitable manner in one or more embodiments or examples. Additionally, without contradiction, those skilled in the art can combine and integrate different embodiments or examples described in the present disclosure, as well as features of different embodiments or examples.

The present disclosure provides an atomizing core, an atomizing assembly, and an atomizing device, which can improve the user experience of the atomizing core.

To realize the above purpose, the technical solutions provided in the present disclosure are as follows.

In a first aspect, some embodiments of the present disclosure provide an atomizing core that includes a heating member and a first liquid-guiding element. The heating member includes a heating portion. The heating portion includes a first heating element, a first connecting element, and a second heating element connected sequentially, and the first heating element and the second heating element are disposed opposite to each other and spaced apart. The first liquid-guiding element is disposed between the first heating element and the second heating element and configured to adsorb and transport aerosol-generating matrix.

The atomizing core provided in the above embodiments of the present disclosure provides the heating portion included in the heating member, enabling the heating portion to include the first heating element and the second heating element spaced apart from each other. The first heating element and the second heating element can independently act on and heat different positions of the first liquid-guiding element that has adsorbed a certain amount of aerosol-generating matrix. Furthermore, the heating member may be an integrated structure, so that the heating portion has high integrity. Additionally, the first liquid-guiding element located between the first heating element and the second heating element can further improve the structural stability of the atomizing core, thus enhancing the atomizing effect and optimizing the user experience of the atomizing core.

In some embodiments of the present disclosure, a resistance value of the first heating element is different from a resistance value of the second heating element.

In some embodiments of the present disclosure, the resistance value of the first heating element is less than the resistance value of the second heating element.

In some embodiments of the present disclosure, an orthographic projection area of the first heating element is less than an orthographic projection area of the second heating element in a thickness direction of the heating portion.

In some embodiments of the present disclosure, an end of the first heating element close to the first connecting element is defined as a first end, and an end of the first heating element facing away from the first connecting element is defined as a second end; and an end of the second heating element close to the first connecting element is defined as a third end, and an end of the second heating element facing away from the first connecting element is defined as a fourth end. A distance between the first end and the second end is less than a distance between the third end and the fourth end.

In some embodiments of the present disclosure, the heating portion further includes a second connecting element, and the second connecting element is disposed at an end of the first heating element facing away from the first connecting element, or at an end of the second heating element facing away from the first connecting element. Alternatively, in some embodiments of the present disclosure, the heating portion further includes two second connecting elements, one of the two second connecting elements is disposed at an end of the first heating element facing away from the first connecting element, and another of the two second connecting elements is disposed at an end of the second heating element facing away from the first connecting element.

In some embodiments of the present disclosure, the heating portion is a tubular structure, and the second connecting element is disposed close to and spaced apart from the first connecting element. The first heating element is located inside the second heating element in a radial direction of the tubular structure, and the second connecting element and the first connecting element are respectively located at both ends of the tubular structure in a circumferential direction of the tubular structure.

In some embodiments of the present disclosure, the heating member further includes a first conductive pin and a second conductive pin, the first conductive pin is connected to the second connecting element, and the second conductive pin is connected to the first connecting element.

In some embodiments of the present disclosure, both the first conductive pin and the second conductive pin extend in an axial direction of the tubular structure.

In some embodiments of the present disclosure, the atomizing core further includes a fixing element, and the fixing element is mounted on an end of the tubular structure in an axial direction of the tubular structure.

In some embodiments of the present disclosure, the fixing element includes a C-shaped structure and/or an O-shaped structure.

In some embodiments of the present disclosure, the atomizing core further includes an atomizing bracket that is a hollow columnar structure, the heating member is bent and disposed on an inner sidewall of the atomizing bracket, and a gap is defined between an outer sidewall of the heating member and an inner sidewall of the atomizing bracket.

In some embodiments of the present disclosure, the atomizing core further includes a second liquid-guiding element at least partially filling the gap.

In some embodiments of the present disclosure, the atomizing core further includes at least two second liquid-guiding elements. The at least two second liquid-guiding elements, the second heating element, the first liquid-guiding element, and the first heating element are sequentially stacked, and the at least two second liquid-guiding elements are configured to transport the aerosol-generating matrix to the first liquid-guiding element. Liquid-guiding rates of the at least two second liquid-guiding elements increase sequentially in a transportation direction of the aerosol-generating matrix, and the liquid-guiding rates of the at least two second liquid-guiding elements are greater than a liquid-guiding rate of the first liquid-guiding element.

In some embodiments of the present disclosure, porosities of the at least two second liquid-guiding elements increase sequentially in the transportation direction of the aerosol-generating matrix, and the porosities of the at least two second liquid-guiding elements are greater than a porosity of the first liquid-guiding element.

In some embodiments of the present disclosure, the atomizing core further includes an atomizing bracket, the heating member is disposed on an inner sidewall of the atomizing bracket, and an inner sidewall of the atomizing bracket is in contact with an outer sidewall of an outermost one of the at least two second liquid-guiding elements.

In some embodiments of the present disclosure, the inner sidewall of the atomizing bracket is provided with a positioning strip extending in a vertical direction, and both ends of the heating member abut against a sidewall of the positioning strip.

In some embodiments of the present disclosure, both the first liquid-guiding element and the at least two second liquid-guiding elements are liquid-guiding cotton, and a heating temperature of the first heating element is lower than a heating temperature of the second heating element.

In a second aspect, some embodiments of the present disclosure provide an atomizing assembly including the above-mentioned atomizing core and a base disposed at a bottom of the atomizing core.

In a third aspect, some embodiments of the present disclosure further provide an atomizing device including the above-mentioned atomizing core and a power supply module, and the power supply module is electrically connected to the atomizing core.

Compared with the prior art, the present disclosure includes beneficial effects as follows.

The atomizing core provided in the embodiments of the present disclosure includes the heating member and the first liquid-guiding element. The first heating element and the second heating element spaced apart can enhance the integrity of the heating member and improve the structural stability of the atomizing core. Additionally, the first liquid-guiding element cooperates with the heating member to optimize the atomizing effect of the heating member, thus improving the service effect and prolonging the service life of the atomizing core. The atomizing core with the above heating member can improve the flow rate and the flow direction of the aerosol-generating matrix in the first liquid-guiding element, thus reducing the risk of core charring and prolonging the service life of the atomizing core. The atomizing assembly and the atomizing device provided in the embodiments of the present disclosure include the beneficial effects of any one or more atomizing cores described above, which will not be repeated here.

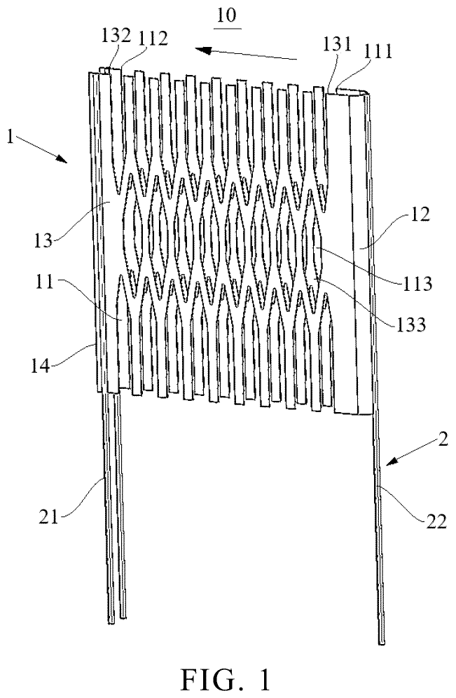

Referring to FIGS. 1 to 5, some embodiments of the present disclosure provide an atomizing core 100 that includes a heating member 10 and a first liquid-guiding element 20. The heating member 10 includes a heating portion 1 and a pin 2.

In the present disclosure, the heating portion 1 and the pin 2 of the heating member 10 may be integrally formed or fixedly connected by welding. In the embodiments shown in FIG. 1, the heating portion 1 and the pin 2 of the heating member 10 are integrally formed.

The heating portion 1 includes a first heating element 11, a first connecting element 12, and a second heating element 13 that are sequentially arranged in a length direction of the heating portion 1. The first heating element 11 and the second heating element 13 are disposed opposite to each other and spaced apart. In the present disclosure, the length direction of the heating portion 1 refers to a length direction of the heating portion 1 in an unfolded state or a curled state.

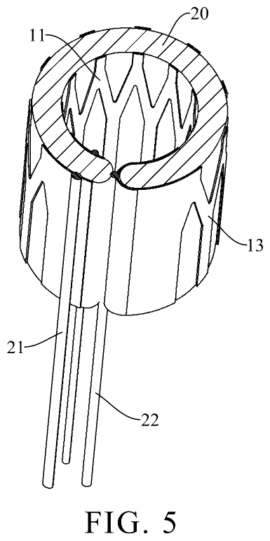

As shown in FIG. 5, the first liquid-guiding element 20 is disposed between the first heating element 11 and the second heating element 13 for adsorbing and transporting aerosol-generating matrix.

As shown in FIG. 1, the heating portion 1 adopts a double-layer sheet structure, and both the first heating element 11 and the second heating element 13 are mesh heating sheets that are disposed opposite to each other. The heating portion 1 is folded along its length direction, so that both ends of the heating portion 1 in the length direction are arranged facing to each other. In this point, the first heating element 11 and the second heating element 13 are disposed opposite to each other, enabling better integrity of the heating portion 1. The first liquid-guiding element 20 located between the first heating element 11 and the second heating element 13 can further improve the structural strength and the structural stability of the heating portion 1.

The first liquid-guiding element 20 is capable of adsorbing an appropriate amount of aerosol-generating matrix, realizing the transport or delivery of the aerosol-generating matrix in the first liquid-guiding element 20. By providing the first liquid-guiding element 20 between the first heating element 11 and the second heating element 13 of the heating member 10, the first heating element 11 and the second heating element 13 can independently heat the aerosol-generating matrix adsorbed at different positions of the first liquid-guiding element 20.

In the present disclosure, the term “fit with” means that a surface of the first liquid-guiding element 20 is in contact with, conforms to, or abuts against an opposite surface of either the first heating element 11 or the second heating element 13.

For example, two opposite surfaces of the first liquid-guiding element 20 are in contact with a surface of the first heating element 11 and a surface of the second heating element 13, respectively. Alternatively, the two opposite surfaces of the first liquid-guiding element 20 abut against the surface of the first heating element 11 and the surface of the second heating element 13, respectively.

In some embodiments, the first liquid-guiding element 20 is made of a porous material. This porous material may have a capillary structure designed to facilitate the transport of the aerosol-generating matrix.

For example, the first liquid-guiding element 20 may be made of one or more materials such as organic cotton, glass fibers, or ceramic fibers, ensuring that the first liquid-guiding element 20 has better adsorption and transport performance for the aerosol-generating matrix. This enables the first liquid-guiding element 20 to continuously adsorb the aerosol-generating matrix and transport it to the heating member 10, ensuring a continuous and stable supply of the aerosol-generating matrix to the heating member 10.

Depending on the material, the transport of the aerosol-generating matrix in the first liquid-guiding element 20 may be directional or non-directional.

In some embodiments, the first heating element 11 and the second heating element 13 may have different resistance values. For example, a resistance value of the first heating element 11 may be greater than a resistance value of the second heating element 13. Alternatively, the resistance value of the first heating element 11 may be less than the resistance value of the second heating element 13.

It can be understood that, the structure of the heating portion 1 can be adjusted, and the first heating element 11 and the second heating element 13 with different resistance values can be spaced apart from each other. In this case, the first heating element 11 and the second heating element 13 can independently act on different positions of the first liquid-guiding element 20 adsorbed with a certain amount of aerosol-generating matrix. Under the heating effect of the heating portion 1, the fluidity of the aerosol-generating matrix can be improved. Additionally, two heating elements with different resistance values can guide the aerosol-generating matrix, which has been heated by one heating element with lower power, to flow toward a side of another heating element with higher power. This not only enhances the atomizing effect but also improves problems of carbon deposition and core charring in the heating member 10, thus improving the service effect and prolonging the service life of the heating member 10.

In some embodiments, the resistance value of the first heating element 11 is less than the resistance value of the second heating element 13.

When the heating member 10 generates heat upon being powered, the flow rate of the aerosol-generating matrix can be accelerated under the effect of heat. When the resistance value of the second heating element 13 is greater than the resistance value of the first heating element 11, the second heating element 13 may be used to preheat the aerosol-generating matrix in the first liquid-guiding element 20 to increase the flow rate of the aerosol-generating matrix. The first heating element 11 may be used to heat the aerosol-generating matrix in the first liquid-guiding element 20 to atomize it and generate aerosol.

In an energized state, the second heating element 13 with a higher resistance value may be used to preheat the aerosol-generating matrix, and the first heating element 11 with a lower resistance value may be used to heat the aerosol-generating matrix. After the preheating treatment, the flow rate of the aerosol-generating matrix adsorbed in the first liquid-guiding member 20 is accelerated, and the aerosol-generating matrix flows toward the first heating element 11 and is finally atomized under the heating effect of the first heating element 11.

Under the preheating effect of the second heating element 13, the aerosol-generating matrix can flow from a side close to the second heating element 13 to a side close to the first heating element 11, and more aerosol-generating matrix can flow into the first liquid-guiding element 20.

Considering the limited storage capacity of the first liquid-guiding element 20 for storing the aerosol-generating matrix, the amount of stored aerosol-generating matrix in the first liquid-guiding element 20 depends on both an adsorption rate of the aerosol-generating matrix by the first liquid-guiding element 20 and a release rate of the aerosol at the first heating element 11 of the heating member 10. When these two rates achieve a dynamic balance, the first liquid-guiding element 20 can operate continuously and stably without core carbonization. However, if the release rate of the aerosol exceeds the adsorption rate of the aerosol-generating matrix, the first liquid-guiding element 20 is prone to dry burning due to insufficient supply of aerosol-generating matrix, which may lead to core carbonization. Therefore, in the embodiments of the present disclosure, by configuring the heating member 10 to include the second heating element 13 with a preheating function and the first heating element 11 with a heating function, while the first heating element 11 generates the aerosol, the second heating element 13 can preheat part of the aerosol-generating matrix in the first liquid-guiding element 20. This accelerates the flow rate of the aerosol-generating matrix in the first liquid-guiding element 20, thereby increasing the adsorption rate of the aerosol-generating matrix by the first liquid-guiding element 20. Consequently, it alleviates the problem of insufficient supply of the first liquid-guiding element 20, reduces the risk of dry burning in the contact area between the first liquid-guiding element 20 and the first heating element 11, and reduces the risk of core charring in the first liquid-guiding element 20, thus prolonging the service life of the atomizing core 100.

In some embodiments, the resistance value of the first heating element 11 and the resistance value of the second heating element 13 may both range from 0.01Ω to 10Ω, for example, 0.01Ω, 0.05Ω, 0.1Ω, 0.5Ω, 1Ω, 1.5Ω, 2Ω, 3Ω, 5Ω, 6Ω, 8Ω, 9Ω, 10Ω, etc.

In some embodiments, the resistance value of the first heating element 11 may range from 0.2Ω to 1.5Ω. Within this range, adaptive adjustments can be made based on design requirements. For example, the resistance value of the first heating element 11 may be 0.2Ω, 0.3Ω, 0.4Ω, 0.5Ω, 0.6Ω, 0.7Ω, 0.8Ω, 0.9Ω, 1.0Ω, 1.1Ω, 1.2Ω, 1.3Ω, 1.4Ω, 1.5Ω, etc.

In some embodiments, the resistance value of the second heating element 13 may range from 1.0Ω to 2.0Ω. Within this range, adaptive adjustments can be made based on design requirements. For example, the resistance value of the second heating element 13 may be 1.0Ω, 1.1Ω, 1.2Ω, 1.3Ω, 1.4Ω, 1.5Ω, 1.6Ω, 1.7Ω, 1.8Ω, 1.9Ω, 2.0Ω, etc.

It should be noted that the resistance value of the first heating element 11 shall always remain less than the resistance value of the second heating element 13. For example, when the resistance value of the second heating element 13 is 1.0Ω, the resistance value of the first heating element 11 is less than 1.0Ω.

In some embodiments, the resistance value of the first heating element 11 ranges from 0.2Ω to 0.8Ω, and the resistance value of the second heating element 13 ranges from 1.5Ω to 2.0Ω.

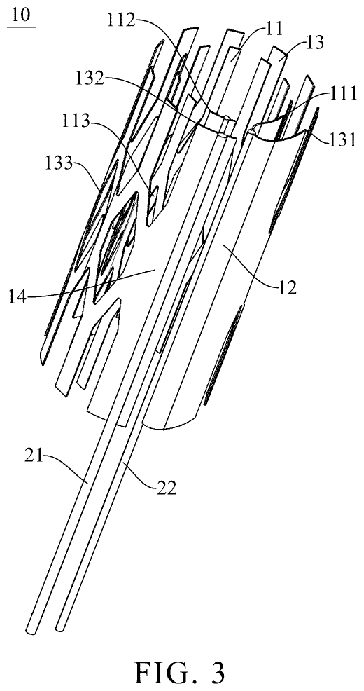

In some embodiments, as shown in FIG. 1 and FIG. 3, an end of the first heating element 11 close to the first connecting element 12 is defined as a first end 111, and an end of the first heating element 11 facing away from the first connecting element 12 is defined as a second end 112; and an end of the second heating element 13 close to the first connecting element 12 is defined as a third end 131, and an end of the second heating element 13 facing away from the first connecting element 12 is defined as a fourth end 132. The first heating element 11 is connected to the first connecting element 12 through the first end 111. The second heating element 13 is connected to an end of the first connecting element 12 facing away from the first heating element 11 through the third end 131.

In some embodiments, the heating member 10 further includes one or more second connecting elements 14. In some implementations, the heating member 10 includes one second connecting element 14, the second connecting element 14 is disposed at an end of the first heating element 11 facing away from the first connecting element 12; alternatively, the second connecting element 14 is disposed at an end of the second heating element 13 facing away from the first connecting element 12. In some implementations, the heating member 10 includes two second connecting elements 14, one of the two second connecting elements 14 is disposed at an end of the first heating element 11 facing away from the first connecting element 12, and another of the two second connecting elements 14 is disposed at an end of the second heating element 13 facing away from the first connecting element 12. In the embodiments shown in FIG. 1, the heating member 10 includes two second connecting elements 14, the second end 112 of the first heating element 11 is connected to one second connecting element 14, and the fourth end 132 of the second heating element 13 is connected to another second connecting element 14.

In some embodiments, an orthographic projection area of the first heating element 11 is less than an orthographic projection area of the second heating element 13 in a thickness direction of the heating portion 1.

In some embodiments, when the first heating element 11 and the second heating element 13 have the same thickness and height, and are processed from the same material, in the direction indicated by the arrow in FIG. 1 (i.e., the length direction of the heating portion 1), a distance between the first end 111 and the second end 112 is less than a distance between the third end 131 and the fourth end 132. In this point, the orthographic projection area of the first heating element 11 is less than the orthographic projection area of the second heating element 13 in the thickness direction of the heating portion 1, and the resistance value of the first heating element 11 is less than the resistance value of the second heating element 13.

In some embodiments, as shown in FIG. 1, the heating portion 1 is formed by bending a mesh heating sheet with a certain thickness, and the first heating element 11, the first connecting element 12, the second heating element, and the second connecting element 14 are integrally formed.

In some embodiments, the first heating element 11 is provided with a plurality of first mesh holes 113, and at least part of the first mesh holes 113 are sequentially arranged in an extension direction of the heating portion 1. Similarly, the second heating element 13 is provided with a plurality of second mesh holes 133, and at least part of the second mesh holes 133 are sequentially arranged in the extension direction of the heating portion 1.

In some embodiments, since the resistance values of the first heating element 11 and the second heating element 13 are different, a width of a mesh strip formed between two adjacent first mesh holes 113 is different from a width of a mesh strip formed between two adjacent second mesh holes 133.

In some embodiments, the first heating element 11 and the second heating element 13 have different thicknesses. The first heating element 11 and the second heating element 13 with different thicknesses can be processed independently, and then the first heating element 11 and the second heating element 13 are spliced and connected by welding to form the heating portion 1.

For example, the heating portion 1 is formed by welding, the first heating element 11 and the second heating element 13 are made of two different metal materials. The first heating element 11 and the second heating element 13 may be fixedly connected by welding, high-temperature pressing, or other methods.

In some embodiments, the heating portion 1 may further include a third heating element. The third heating element is spaced apart from the second heating element 13 through another first connecting element 12. A resistance value of the third heating element may be different from the resistance values of both the first heating element 11 and the second heating element 13, so as to provide the heating member 10 with a more flexible adjustment range for resistance values. Details are not described herein again.

In some embodiments, the pin 2 includes a first conductive pin 21 and a second conductive pin 22. The first conductive pin 21 is connected to the second connecting element 14, and the second conductive pin is connected to the first connecting element 12.

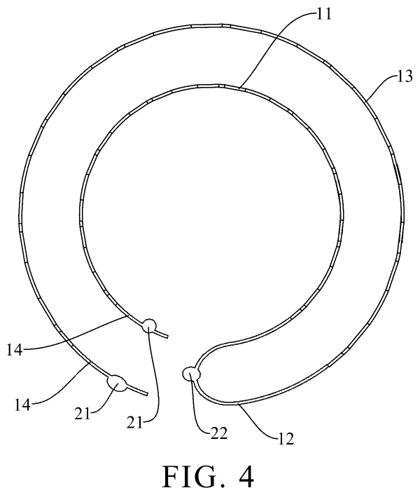

Referring to FIG. 1 and FIG. 4, the number of the first conductive pins 21 is two. The two first conductive pins 21 may be connected to the first heating element 11 and the second heating element 13 respectively through two second connecting elements 14. The two first conductive pins 21 are located at both ends of the heating portion 1 in the length direction. Since the first heat-generating element 11 and the second heat-generating element 13 are arranged opposite to each other, the two first conductive pins 21 connected to both ends of the heating portion 1 are also arranged opposite to each other.

Referring to FIG. 1, in the length direction of the heating portion 1, the second conductive pin 22 is connected to the middle of the heating portion 1 through the first connecting element 12 located between the first heating element 11 and the second heating element 13. The two first conductive pins 21 are connected to both ends of the heating portion 1 through an end of the first heating element 11 away from the second heating element 13 and an end of the second heating element 13 away from the first heating element 11, respectively.

With the first heating element 11 as a reference, the first conductive pin 21 and the second conductive pin 22 are respectively located at two ends of the first heating element 11. The second conductive pin 22 may be used in cooperation with different first conductive pins 21 to realize heating control of the first heating element 11 and the second heating element 13, respectively.

Under the action of the first conductive pin 21 and the second conductive pin 22, the first heating element 11 and the second heating element 13 are connected in parallel through the first connecting element 12. Correspondingly, during use, when the heating member 10 is electrically connected to a circuit through the two first conductive pins 21, the overall resistance value of the heating member 10 is at the lowest. When the heating member 10 is electrically connected to the circuit through the first conductive pin 21 and the second conductive pin 22, only the first heating element 11 or the second heating element 13 is energized, causing the resistance value of the heating member 10 to increase relatively. Under a constant voltage, the smaller the resistance value connected to the connected circuit, the higher the heating power.

In some embodiments, when the heating member 10 is connected to a circuit through the two first conductive pins 21, the heating power of the heating member 10 reaches its maximum. When the heating member 10 is connected to the circuit through the first conductive pin 21 and the second conductive pin 22, the heating power of the heating member depends on the resistance value of a certain region in its energized state. Since the resistance values of the first heating element 11 and the second heating element 13 are different, the heating power of the first heating element 11 when connected to the circuit is different from the heating power of the second heating element 13 when connected to the circuit.

During operation, the heat generated by the heating member 10 may be directly transmitted to the first liquid-guiding element 20 connected to it. The first liquid-guiding element 20 may be disposed between the first heating element 11 and the second heating element 13. Therefore, by adjusting the pin 2 through which the heating member 10 is connected to the circuit, the temperature at the first liquid-guiding element 20 can be changed by adjusting the heating power. Moreover, different positions of the first liquid-conducting element 20 can even be set to have different temperatures, which can improve the potential problem of core charring in the first liquid-guiding element 20, thus improving the problem of carbon deposition in the heating member 10.

In some embodiments, both the first conductive pin 21 and the second conductive pin 22 are provided on the same side of the heating portion 1. Of course, in other similar embodiments, the first conductive pin 21 and the second conductive pin 22 are respectively located on both sides of the heating portion 1 according to the actual installation space requirements.

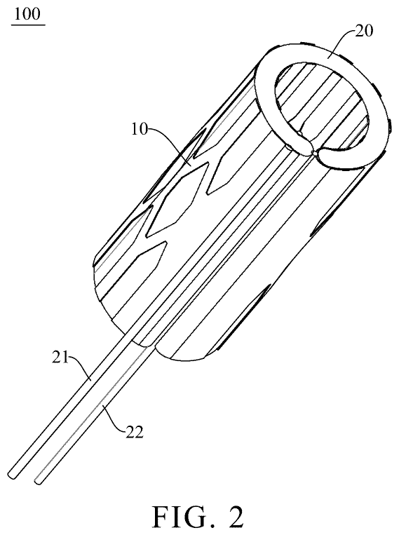

In some embodiments, the heating member 10 may be configured as a columnar or approximately columnar C-shaped sheet structure (also referred to as an arc-shaped sheet structure), as shown in FIG. 2 and FIG. 3. The heating member 10 is arranged as a tubular structure where the second connecting element 14 and the first connecting element 12 are close to each other. In a circumferential direction of the tubular structure, the first connecting element 12 and the second connecting element 14 are respectively located at both ends of the tubular structure. The first heating element 11 is located inside the second heating element 13 in a radial direction of the tubular structure. A length of the first heating element 11 (i.e., the length of the arc-shaped structure connecting the first end 111 and the second end 112) is less than a length of the second heating element 13 (i.e., the length of the arc-shaped structure connecting the third end 131 and the fourth end 132) in the circumferential direction of the tubular structure.

In some embodiments, the tubular structure is provided with a notch penetrating the tubular structure in its axial direction, as shown in FIG. 3 and FIG. 4. The second connecting element 14 and the first connecting element 12 are respectively located on both sides of the notch in the circumferential direction of the tubular structure and do not contact each other.

Referring to FIG. 2, FIG. 3, and FIG. 4, in the tubular structure formed by winding the heating member 10, a hollow channel communicating with an atomizing channel is formed in the tubular structure. The first heating element 11 located on the inner side is close to the hollow channel, and correspondingly, the second heating element 13 is farther away from the hollow channel relative to the first heating element 11. When the atomizing core 100 is mounted into the atomizing device, the aerosol-generating matrix adsorbed by the first liquid-guiding element 20 can generate aerosol under the heating effect of the heating member 10. The generated aerosol enters the atomizing channel through the hollow channel and finally flows to a suction nozzle communicated with the atomizing channel.

Referring to FIG. 2 and FIG. 5, after the heating member 10 is wound to form the tubular structure, the first liquid-guiding element 20 is located between the first heating element 11 and the second heating element 13. Moreover, two opposite sides of the first liquid-guiding element 20 in the thickness direction can respectively cooperate with the first heating element 11 and the second heating element 13, so that the first heating element 11 and the second heating element 13 can independently heat different positions of the first liquid-guiding element 20.

When both the first heating element 11 and the second heating element 13 are energized, the heating power of the first heating element 11 is greater than the heating power of the second heating element 13. Therefore, the aerosol-generating matrix may be preheated under the heating of the second heating element 13 to enhance its fluidity in the first liquid-guiding element 20, then flow along the first liquid-guiding element 20 toward the first heating element 11, and finally achieve atomization under the heating effect of the first heating element 11. The above structure can effectively reduce the probability of core charring in the heating portion 1, as well as the probability of core charring in the related liquid-guiding structures or liquid storage structures being in contact with the heating portion 1, thus improving the service effect and service life of the heating member 10.

Referring to FIG. 2 and FIG. 3, both the first conductive pin 21 and the second conductive pin 22 are provided on the same side of the tubular heating portion 1, and the two extend in the axial direction of the tubular heating portion 1. Under the premise that the heating portion 1 is wound into the structure shown in FIG. 2 and FIG. 3, the second conductive pin 22 and the two first conductive pins 21 are always kept out of contact with each other.

Referring to FIG. 4, in an axial direction of the heating member 10, a cross-sectional area of the first conductive pin 21 connected to the first heating element 11 is less than a cross-sectional area of the second conductive pin 22 connected to the second heating element 13.

It can be understood that a cross-sectional area (also interpretable as an area of an end surface) of the second conductive pin 22 connected to the first connecting element 12 is less than a cross-sectional area of one first conductive pin 21 connected to the second heating element 13. Correspondingly, the cross-sectional area of the second conductive pin 22 connected to the first connecting element 12 is greater than a cross-sectional area of another first conductive pin 21 connected to the first heating element 11.

It can be understood that, in the atomizing core 100 provided in the embodiments of the present disclosure, by providing the heating member 10 including the first heating element 11 and the second heating element 13 arranged at intervals and having different resistance values, the preheating and heating treatment of the aerosol-generating matrix at different positions of the first liquid-conducting element 20 can be realized. This improves the problem of carbon deposition in the atomizing core 100, enhances the service effect and the service life of the atomizing core 100, and improves the problem of core charring caused by dry burning of the atomizing core 100.

In the above embodiments, the atomizing core 100 as a whole is a tubular structure, where the heating member 10 is bent such that the second connecting element 14 and the first connecting element 12 are close to each other, forming a tubular structure with a notch. In some embodiments, the atomizing core 100 further includes at least one fixing element 50. The fixing element 50 is mounted on an end of the heating portion 1 in the axial direction of the heating portion 1.

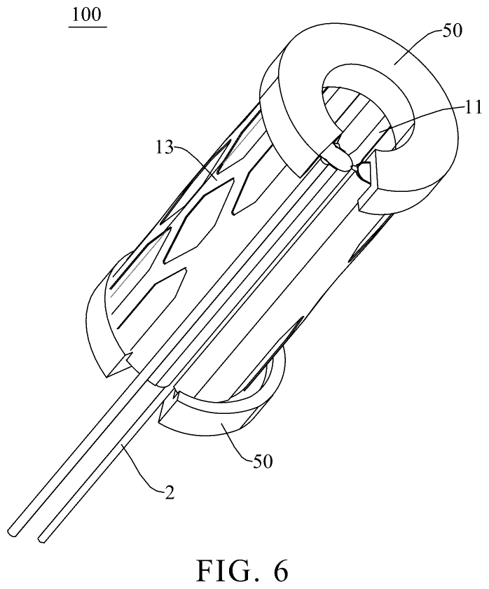

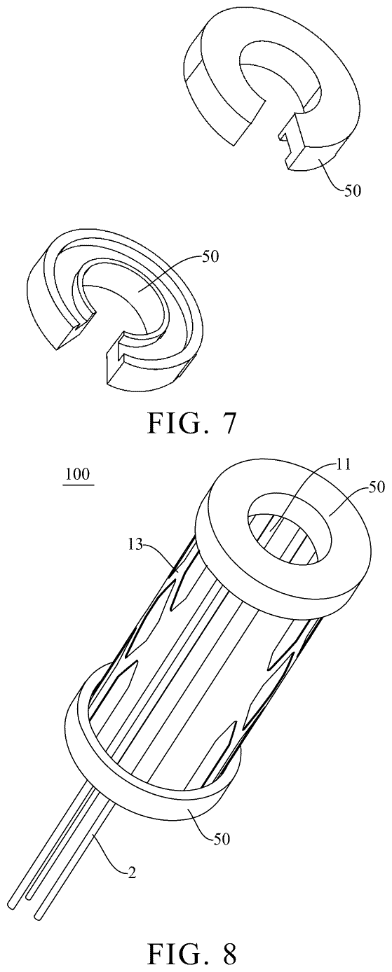

Referring to FIG. 6 and FIG. 7, the number of fixing elements 50 is two, and the two fixing elements 50 are respectively mounted on both ends of the heating portion 1 in the axial direction of the heating portion 1. The two fixing elements 50 may have the same structure. For example, the fixing element 50 has an arc-shaped structure with a notch, which may be referred to as a C-shaped structure. The middle of an end of the fixing element 50 that contacts the heating portion 1 is recessed inward to fix and limit the heating portion 1 and the first liquid-conducting element 20. Meanwhile, the notch of the fixing element 50 is aligned with the notch of the heating portion 1 (tubular structure). In the axial direction of the tubular structure, a width of the notch of the fixing element 50 is greater than a width of the notch of the tubular structure, allowing the fixing element 50 to avoid interfering with the pin 2 of the heating member 10. Additionally, the notch of the fixing element 50 reduces the assembly difficulty of the fixing element 50.

The fixing element 50 can limit and fix the heating member 10 and the first liquid-guiding element 20 in the axial direction, preventing axial displacement between the first liquid-guiding element 20 and the heating member 10. Additionally, the fixing element 50 can provide better fixing and supporting effects for the heating member 10, avoiding defects such as deformation of the first heating element 11 and/or the second heating element 13 of the heating member 10 during the assembly process.

When mounting the atomizing core 100 with the fixing element 50 into the atomizing device, the fixing element 50 can provide a sealing effect on the first liquid-guiding element 20 in the axial direction, so as to improve the potential liquid leakage defect of the atomizing core 100 in the axial direction.

In some embodiments, the fixing element 50 is made of an insulating material.

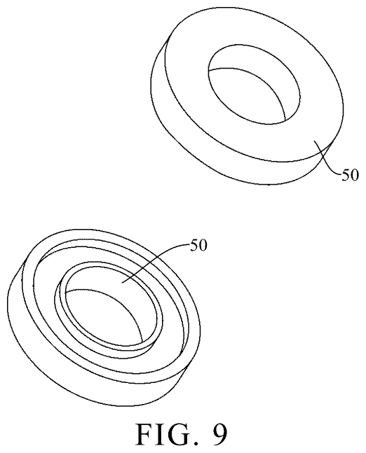

In some embodiments, the two fixing elements 50 may have the same structure, for example, each fixing element 50 may have an O-shaped structure, as shown in FIG. 8 and FIG. 9. In some embodiments, the two fixing elements 50 have different structures, for example, one of the two fixing elements 50 has a C-shaped structure, and another of the two fixing elements 50 has an O-shaped structure.

Specifically, the number of fixing elements 50 is two, and both are hollow annular structures. Similarly, portions of the two fixing elements 50 that contact both ends of the heating portion 1 and the first liquid-guiding element 20 are each recessed to fix and limit the heating portion 1 and the first liquid-guiding element 20. It should be noted that one of the two fixing elements 50 is provided with one or more perforations for the pin 2 to pass through. As shown in FIG. 8, the lower fixing element 50 is provided with three perforations for the pin 2 to pass through. The pin 2 of the heating member 10 is connected to the fixing element 50 through the three perforations. The upper fixing element 50 may not be provided with the aforementioned perforations, as shown in FIG. 9. Of course, considering the processing cost, the O-shaped fixing element 50 is provided with perforations, and the perforations do not affect the overall strength of the fixing element 50.

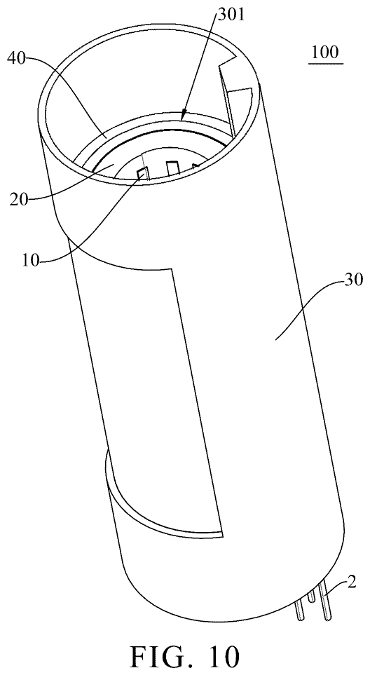

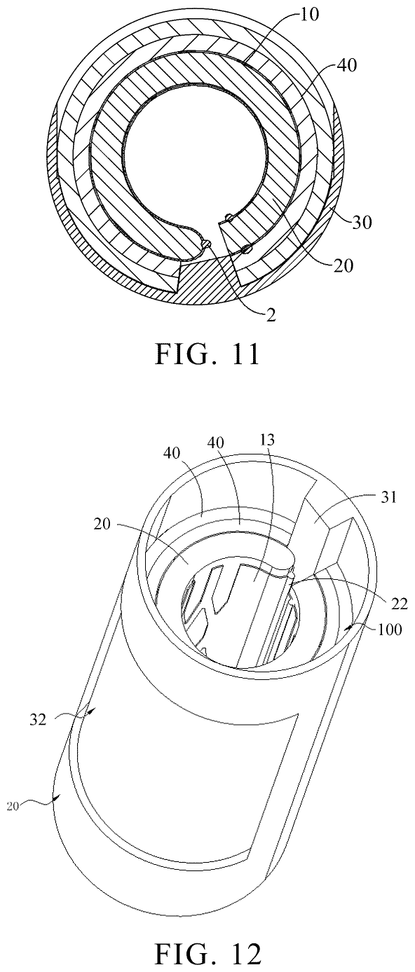

In some embodiments, the atomizing core 100 further includes an atomizing bracket 30, as shown in FIG. 10 and FIG. 11. The atomizing bracket 30 is a hollow columnar structure as a whole. The heating member 10 wound into a tubular structure is mounted into the atomizing bracket 30, and a gap 301 is defined between an outer sidewall of the heating member 10 and an inner sidewall of the atomizing bracket 30.

The gap 301 can prevent the heating member 10 from directly contacting the inner sidewall of the atomizing bracket 30.

In some embodiments, an outer peripheral sidewall of the fixing element 50 fits with the inner sidewall of the atomizing bracket 30. The heating member 10 can block the gap 301 under the fixing action of the fixing element 50 and be mounted into the atomizing bracket 30.

In some embodiments, the atomizing core 100 further includes a second liquid-guiding element 40, and at least part of the second liquid-guiding element 40 fills the gap 301, so that the heating member 10 and the first liquid-guiding element 20 can be firmly mounted into the atomizing bracket 30.

At least part of the second liquid-guiding element 40 located in the gap 301 may be in contact with the first liquid-guiding element 20 through the second mesh holes 133 of the second heating element 13.

Through the above arrangement, at least part of the aerosol-generating matrix adsorbed in the second liquid-guiding element 40 can flow toward the first liquid-guiding element 20. When the second heating element 13 is in an energized heating state, it can further enhance the flow rate of the aerosol-generating matrix in the second liquid-guiding element 40.

In some embodiments, when both the first heating element 11 and the second heating element 13 of the heating member 10 are in an energized heating state, during this process, as the aerosol is continuously generated, the aerosol-generating matrix located outside the atomizing bracket 30 can continuously flow toward the first liquid-guiding element 20 through the second liquid-guiding element 40, realizing the replenishment of the aerosol-generating matrix in the first liquid-guiding element 20. Meanwhile, as the aerosol is continuously generated, the aerosol-generating matrix located in the first liquid-guiding element 20 can be preheated at the second heating element 13 and flow toward the first heating element 11, which improves the risk of core charring caused by insufficient supply of the aerosol-generating matrix in the part where the first liquid-guiding element 20 is in contact with the first heating element 11.

In some embodiments, a material of the second liquid-guiding element 40 may be the same as a material of the first liquid-guiding element 20. Of course, the second liquid-guiding element 40 may be made of a material such as a non-woven fabric or organic cotton.

Referring to FIG. 10 and FIG. 11, a circumferential sidewall of the atomizing bracket 30 is provided with a flow-guiding window (not shown in the figures). When the atomizing core 100 is mounted into the atomizing device, the aerosol-generating matrix in the atomizing device can flow toward the second liquid-guiding element 40 through the above-described flow-guiding window, so as to realize the replenishment of the aerosol-generating matrix in the second liquid-guiding element 40.

The second liquid-guiding element 40 may be a single-layer structure or a double-layer structure located in the atomizing bracket 30. Of course, as shown in FIG. 11, a part of the second liquid-guiding element 40 may be provided to pass through the flow-guiding window of the atomizing bracket 30 and extend to the outside of the atomizing bracket 30, so as to further adsorb and guide the aerosol-generating matrix outside the atomizing bracket 30 to flow toward the first liquid-guiding element 20 through the second liquid-guiding element 40.

It can be understood that the atomizing core 100 provided in the above embodiments can improve the flow rate of the aerosol-generating matrix in the first liquid-guiding element 20, so as to address the problems of carbon deposition and core charring, thus effectively improve the service effect and service life of the atomizing core 100.

In the atomizing cores of the related art, the commonly used heating elements are roughly divided into spiral columnar heating elements and planar heating elements. In disposable or open-type atomizers, the planar heating elements are more frequently used. A heating mesh may be attached to a side of the inner wrapping cotton of the planar heating element, and then the entire structure is rolled into a cylinder and packaged as an atomizing core. For the atomizing core adopting this structure, since the heating mesh is directly attached to the inner wrapping cotton, the instantaneous temperature required for atomization is relatively high, which may burn through the inner wrapping cotton and lead to the reduction of the service life of the atomizing core. At the same time, the instantaneous high temperature may cause the carbonization of the aerosol-generating matrix or the inner wrapping cotton. After accumulating on the surface of the heating mesh, it reduces the heating efficiency of the heating mesh at its surface, which may affect the atomizing taste. Moreover, for the aerosol-generating matrix with high viscosity (such as the aerosol-generating matrix with high VG content), the atomizing core adopting this structure is prone to core charring.

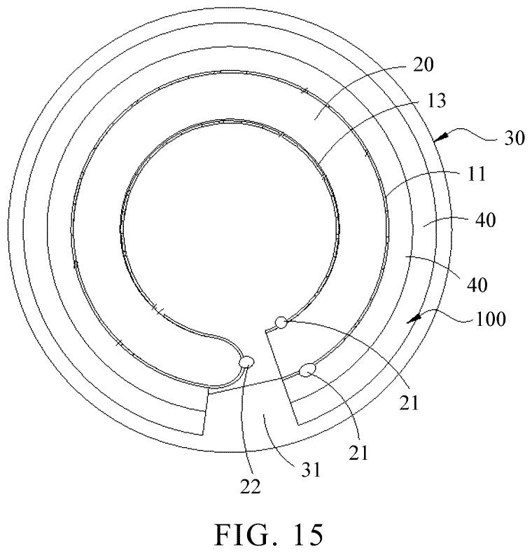

To address the above problems, in some embodiments of the present disclosure, the number of the second liquid-guiding elements 40 is two. Referring to FIGS. 12 to 17, the atomizing core 100 includes two second liquid-guiding elements 40, the first heating element 11, the first liquid-guiding element 20, and the second heating element 13, which are sequentially stacked. That is, two liquid-guiding elements and two heating members are combined in a stacked configuration to form the atomizing core 100. The first liquid-guiding element 20 is disposed between the first heating element 11 and the second heating element 13, and both surfaces of the first liquid-guiding element 20 are respectively in contact with the first heating element 11 and the second heating element 13. Both the first heating element 11 and the second heating element 13 have a certain resistance and can generate heat when energized.

In the above embodiments, the first heating element 11 can preheat the aerosol-generating matrix to improve its fluidity and accelerate the supply rate of the aerosol-generating matrix. Meanwhile, a temperature field is formed in the atomizing core 100, which can reduce the instantaneous atomizing temperature of the second heating element 13, significantly prolong the service life of the heating member 10, and address problems such as carbon deposition and core charring in the heating member 10 caused by high temperatures.

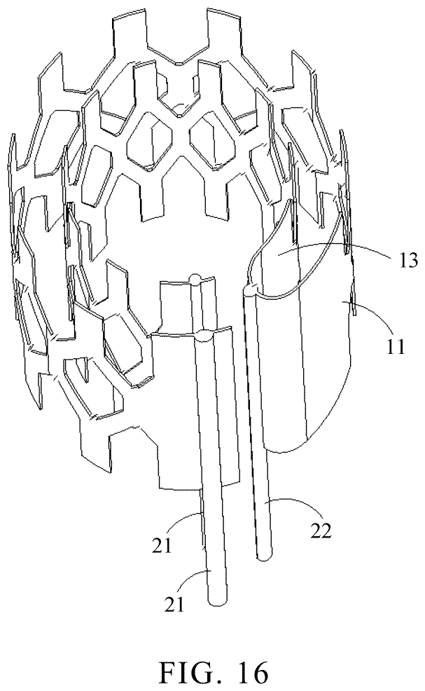

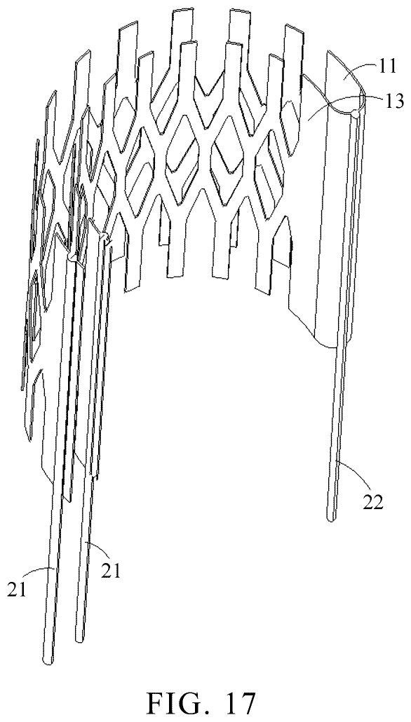

In some embodiments, the first heating element 11 and the second heating element 13 may be in a mesh structure, as shown in FIG. 16 and FIG. 17, which facilitates the volatilization of the aerosol-generating matrix from the gaps of the mesh structure. The second liquid-guiding element 40 can continuously transport the aerosol-generating matrix to the first liquid-guiding element 20, which can prevent the two heating elements, the first heating element 11 and the second heating element 13, from dry burning and avoid the phenomenon of carbon deposition.

As shown in FIG. 14, in the transportation direction of the aerosol-generating matrix (direction F in FIG. 1), liquid-guiding rates of the two second liquid-guiding elements 40 are set to increase sequentially, and the liquid-guiding rate of each second liquid-guiding element 40 is set to be greater than a liquid-guiding rate of the first liquid-guiding element 20. In this way, the transportation rate of the aerosol-generating matrix can be further increased, while the fineness of the aerosol generated after atomization can be improved, and the suction experience can be enhanced. Further, in the transportation direction of the aerosol-generating matrix, porosities of the second liquid-guiding elements 40 may be set to increase sequentially, and the porosity of each second liquid-guiding element 40 may be set to be greater than a porosity of the first liquid-guiding element 20, so as to realize the purpose that the liquid-guiding rates of the second liquid-guiding elements 40 increase sequentially, and the liquid-guiding rate of each second liquid-guiding element 40 is greater than the liquid-guiding rate of the first liquid-guiding element 20.

In some embodiments, the heat temperature of the first heating element 11 is set to be lower than the heat temperature of the second heating element 13 to ensure that the aerosol-generating matrix is atomized at the first heating element 11. By limiting the heating temperature, it is ensured that the first heating element 11 can perform the preheating function, while the second heating element 13 plays the role of atomization.

In some embodiments, the heating temperature of the first heating element 11 may range from 50° C. to 150° C. For example, the heating temperature of the first heating element 11 may be 50° C., 60° C., 70° C., 80° C., 90° C., 100° C., 110° C., 120° C., 130° C., 140° C., 150° C., etc.

In some embodiments, the heating temperature of the second heating element 13 may range from 150° C. to 350° C. For example, the heating temperature of the second heating element 13 may be 151° C., 160° C., 180° C., 200° C., 220° C., 240° C., 260° C., 280° C., 300° C., 320° C., 330° C., 350° C., etc.

In some embodiments, the first heating element 11 is operated before the second heating element 13 to preheat the aerosol-generating matrix to improve its fluidity before the second heating element 13 is atomized.

In some embodiments, both the second liquid-guiding element 40 and the first liquid-guiding element 20 are made of cotton, that is, each liquid-guiding element is liquid-guiding cotton, such as absorbent cotton, organic cotton, or fiber cotton. The use of cotton material is beneficial to improving the volatilization effect of the aerosol-generating matrix, and it is convenient, safe, and harmless. The liquid-guiding cotton may have a single-layer structure or a multi-layer structure. In some embodiments, both the second liquid-guiding element 40 and the first liquid-guiding element 20 are made of linen non-woven fabric, viscose non-woven fabric, American cotton, Austrian cotton, or composite cotton formed from at least two of these materials.

In some embodiments, materials of both the first heating element 11 and the second heating element 13 may include, but are not limited to, stainless steel, an iron-based alloy, a nickel-based alloy, an iron-chromium-aluminum alloy, or a titanium alloy. Other high-temperature resistant conductive metal materials may also be used. Both the first heating element 11 and the second heating element 13 may adopt a regular mesh structure, such as a heating mesh provided with multiple evenly distributed through holes of the same size. Alternatively, Both the first heating element 11 and the second heating element 13 may adopt an irregular mesh structure.

In some embodiments, when both the second liquid-guiding element 40 and the first-liquid guiding element 20 are liquid-guiding cotton, the aerosol-generating matrix is transported from the second liquid-guiding element 40 to the first liquid-guiding element 20 for atomization. When passing through the first heating element 11, it is preheated once. The preheating temperature is lower than the atomizing temperature of the aerosol-generating matrix. The preheating can increase the temperature of the nearby thermal field, and the liquid-guiding cotton also plays a role in heat preservation and insulation, which can keep the temperature field unchanged for a short time. In this way, the aerosol-generating matrix with low-viscosity is formed, and then the aerosol-generating matrix with low-viscosity gradually penetrates to the second heating element 13. After the second heating element 13 is loaded with voltage, it releases heat, and the aerosol-generating matrix with low-viscosity starts to be atomized. Driven by the airflow, the aerosol-generating matrix with low-viscosity flows, thus realizing the atomizing effect. Since the first liquid-guiding element 20 has a high liquid-guiding rate and low porosity, it can atomize relatively delicate aerosol, which can effectively improve the suction experience. Additionally, due to the preheating effect of the first heating element 11, the instantaneous atomizing temperature of the second heating element 13 is reduced, and the atomizing effect can also be achieved at the same time, addressing the problems of carbon deposition and core charring of the heating member 10 caused by high temperatures, and significantly improving the service life of the heating member 10.

In the embodiments shown in FIG. 12, the number of the second liquid-guiding elements 40 is two, and a maximum temperature resistance of one second liquid-guiding element 40 close to the first heating element 11 is greater than a maximum temperature resistance of another second liquid-guiding element 40 away from the first heating element 11.

The atomizing core 100 may be bent and rolled into a cylindrical shape. That is, the liquid-guiding cotton forming the liquid-guide elements and the two heating meshes (the two heating elements) are each curled into a cylindrical shape. An outer side of the outermost liquid-guiding cotton is in contact with the aerosol-generating matrix, that is, it communicates with the chamber of the atomizing device where the aerosol-generating matrix is stored. That is to say, when the atomizing core 100 is bent into a cylindrical shape, the liquid storage chamber storing the aerosol-generating matrix is located outside the outermost liquid-guiding cotton. The aerosol-generating matrix is transported from the outside to the inside of the atomizing core 100. Since the first heating element 11 forms a temperature field in the liquid-guiding cotton, the instantaneous atomizing temperature of the second heating element 13 is reduced. This can effectively improve the problems such as carbon deposition caused by high temperatures and core charring caused by the burning of cotton, thus prolonging the service life of the heating member 10.

It can be understood that the atomizing core 100 may adopt a flat stacked structure, where each liquid-guiding cotton and each heating mesh are horizontally arranged. The uppermost liquid-guiding cotton is in contact with the aerosol-generating matrix, i.e., communicates with the liquid storage chamber storing the aerosol-generating matrix in the atomizing device, and the liquid storage chamber for storing the aerosol-generating matrix is located directly above the atomizing core 100. The cross-sectional shape of the liquid-guiding cotton is not limited to a rectangle form, it can also have an arc-shaped edge or an edge with a notch.

In some embodiments, the number of the second liquid-guiding elements 40 may be three, four, five, or more.

In some embodiments, the atomizing core 100 may be bent into a shape ranging from 0 to 360°, for example, 10°, 30°, 50°, 70°, 90°, 110°, 130°, 150°, 180°, 200°, 220°, 240°, 260°, 280°, 300°, 320°, 340°, 355°, etc.

Compared with the prior art, the atomizing core 100 provided in the embodiments of the present disclosure is provided with two heating elements, and the second liquid-guiding element 40, the first liquid-guiding element 20, and the two heating elements are arranged in a stacked configuration. The first heating element 11 can preheat the aerosol-generating matrix to maintain a certain temperature in the liquid-guiding element, thus reducing the instantaneous atomizing temperature of the second heating element 13. Meanwhile, it can form a low-viscosity fluid state of the aerosol-generating matrix, reducing carbon deposition and core charring caused by high temperatures in the heating member 10, which significantly prolongs the service life of the heating member 10. Additionally, by setting the liquid-guiding rates of the liquid-guiding elements, finer aerosol can be generated during atomization, thus enhancing the suction experience.

In some embodiments, an operating time of the first heating element 11 can be longer than an operating time of the second heating element 13, which can realize the preheating effect and prevent the first liquid-guiding element 20 from burning. In some embodiments, the operating time of the first heating element 11 may range from 0.1 seconds to 5 seconds, with specific values such as 0.1 seconds, 0.2 seconds, 0.3 seconds, 0.5 seconds, 0.8 seconds, 1 second, 1.5 seconds, 2 seconds, 2.5 seconds, 3 seconds, 3.5 seconds, 4 seconds, 4.5 seconds, or 5 seconds, etc.

In some embodiments, the operating time of the second heating element 13 may range from 0.05 seconds to 3 seconds, with specific values such as 0.05 seconds, 0.1 seconds, 0.15 seconds, 0.25 seconds, 0.4 seconds, 0.6 seconds, 0.8 seconds, 1.2 seconds, 1.8 seconds, 2.2 seconds, 2.4 seconds, 2.6 seconds, 2.8 seconds, or 3 seconds, etc.

When the resistance values of the first heating element 11 and the second heating element 13 are different, the atomizing core 100 is formed by laminating liquid-guiding cotton (liquid-guiding elements) with different resistance values and liquid-guiding rates in a stacked configuration with the two heating elements. The first heating element 11 plays a preheating role, forming a temperature field in the liquid-guiding cotton to reduce the instantaneous atomizing temperature of the second heating element 13. This addresses the problems of carbon deposition and core charring, thus prolonging the service life of the atomizing core 100. Meanwhile, setting the liquid-guiding rates and porosities of the liquid-guiding elements enables the generation of finer aerosol during atomization, effectively enhancing the suction experience.

With continued reference to FIGS. 12 to 17, in some embodiments, the atomizing core 100 further includes a cylindrical atomizing bracket 30, and an axial length of the atomizing bracket 30 is greater than an axial length of the heating portion 1. The atomizing bracket 30 is sleeved on an outer side of the second liquid-guiding element 40. The arrangement of the atomizing bracket 30 can maintain the shape of the atomizing core 100 after bending, that is, enable the atomizing core 100 to keep a fixed bending angle and fix the curvature of the atomizing core 100. Meanwhile, it also facilitates fixing the atomizing core 100 in the atomizing device through the atomizing bracket 30. The atomizing bracket 30 may, but is not limited to, adopt a porous metallic element. Both the first heating element 11 and the second heating element 13 may be formed by curling a rectangular sheet mesh and welding the joints to form a cylindrical heating mesh with welded parts at the welding positions. Alternatively, a single metal wire can be directly woven into a seamless cylindrical structure, which has better integrity.

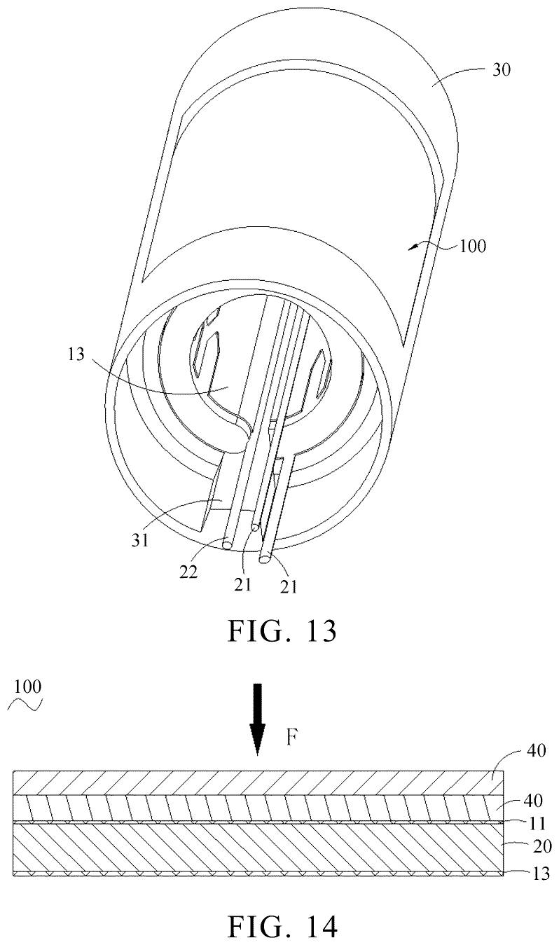

A bending angle of the atomizing core 100 as a whole may range from 180° to 360°. In some embodiments, the bending angle of the atomizing core 100 is greater than 300° and less than 360°. As shown in FIG. 12 and FIG. 13, the first heating element 11 and the second heating element 13 adopt an integrally formed structure. The first heating element 11 and the second heating element 13 are each provided with the first conductive pin 21. The second conductive pin 22 is provided at the junction of the first heating element 11 and the second heating element 13, that is, the first heating element 11 and the second heating element 13 share the second conductive pin 22. The two heating elements share one conductive pin, which saves material usage, reduces production cost, minimizes processing steps, and improves processing efficiency. When the first heating element 11 and the second heating element 13 each adopt a mesh structure, the specific processing steps are as follows:
the entire heating mesh is bent and folded from the middle position, then bent into a shape at a predetermined angle. After that, the first liquid-guiding element 20 is placed between the first heating element 11 and the second heating element 13, and the bent joint between the first heating element 11 and the second heating element 13 is arc-shaped.

In some embodiments, an inner sidewall of the atomizing bracket 30 is provided with a protruding positioning strip 31 extending in a vertical direction. Both ends of the atomizing core 100 after integral curling may be in contact with side surfaces of the positioning strip 31, or one or more of the liquid-guiding elements of the atomizing core 100 may be in contact with the side surfaces of the positioning strip 31. The atomizing bracket 30 may be, but is not limited to, a porous metal element, such as a porous metal element with a mesh structure.

Furthermore, in some embodiments, a side surface of the atomizing bracket 30 is provided with an opening 32. The opening 32 and the positioning strip 31 are located at opposite sides of the atomizing bracket 30, and an opening angle of the opening 32 is nearly half of an opening angle of the atomizing bracket 30, i.e., the central angle occupied by the opening 32 is nearly 180°. This allows the aerosol-generating matrix in the liquid storage chamber to directly contact the outer surface of the atomizing core 100 through the opening 32, thus improving the transportation efficiency.

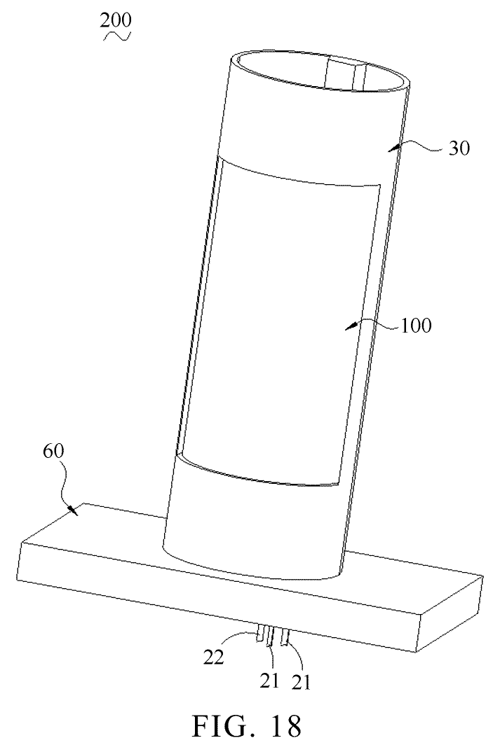

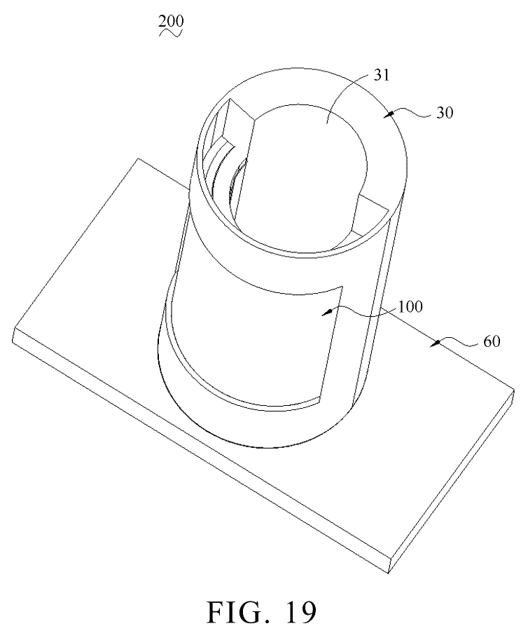

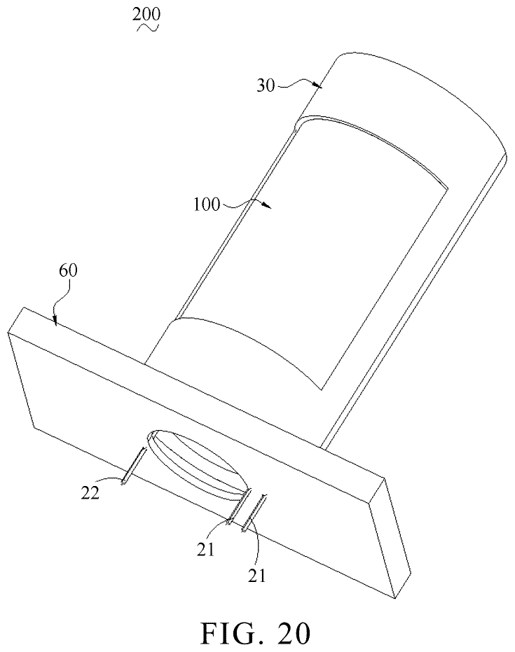

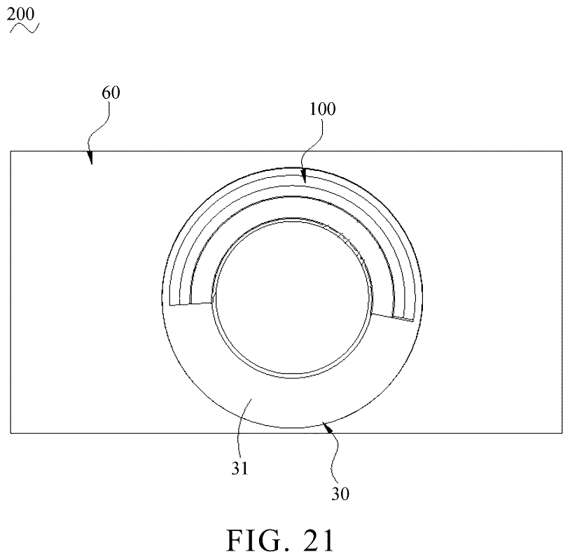

Referring to FIGS. 18 to 21, some embodiments of the present disclosure further provide an atomizing assembly 200 that includes an atomizing core and a base 60 disposed at the bottom of the atomizing core. The atomizing core may adopt the atomizing core 100 as described in any one of the above-mentioned embodiments.

In some embodiments, a top surface of the base 60 has a width and a length both larger than an outer diameter of the atomizing bracket 30. The atomizing bracket 30 may be fixed at the central position of the base 60. The bottom of the atomizing bracket 30 is fixedly mounted on the base 60. The base 60 is provided with through holes for the conductive pins of the first heating element 11 and the second heating element 13 to extend out. A gap is defined between the top surface of the base 60 and the atomizing core 100. Specifically, the base 60 and the atomizing bracket 30 can be assembled and fixed by clamping or other methods. The base 60 may adopt a rectangular structure or a structure that fits with a housing of an aerosol generating device. In this way, after the atomizing assembly 200 is placed in the housing, the base 60 and the housing are easily fixed after positioning and assembling, so as to improve the assembly efficiency of the atomizing product.

The bending angle of the atomizing core 100 as a whole is 180°, and the central angle formed by two ends of the positioning strip 31 located in the atomizing bracket 30 and the center of the atomizing bracket 30 is 180°, meaning that the positioning strip 31 is semicircular. When the heating member and the liquid-guiding elements are assembled into the atomizing bracket 30, each liquid-guiding element abuts against the corresponding side surface of the positioning strip 31. A side of the atomizing bracket 30 is also provided with an opening, the first heating element 11 and the second heating element 13 of the atomizing core 100 share one second conductive pin 22. The base 60 is fixedly mounted at the bottom of the atomizing bracket 30, and the first conductive pin 21 and the second conductive pin 22 extend out from the bottom surface of the base 60.

It can be understood that, when the atomizing core 100 is bent at other angles, another atomizing bracket 30 similar to that described in the above embodiments can also be used. A positioning strip of corresponding size is provided on an inner sidewall of the atomizing bracket 30, so that the structure formed by the heating member and the liquid-guiding elements can maintain a stable bending angle after being assembled into the atomizing bracket 30, which can enhance the structural stability of the atomizing core 100, thus enhancing the structural stability of the atomizing assembly 200.

Some embodiments of the present disclosure further provide an aerosol generating device that includes the atomizing assembly 200 described in any one of the above embodiments. The aerosol generating device further includes a housing, with which the atomizing assembly 200 is accommodated. A liquid storage chamber for storing the aerosol-generating matrix is provided in the housing, and this liquid storage chamber communicates with an outer surface of the second liquid-guiding element 40, which is the farthest from the second heating element 13 in the atomizing core 100.

Some embodiments of the present disclosure further provide an atomizing device that includes an atomizing core and a power supply module. The atomizing core may adopt the atomizing core 100 described in any one of the above embodiments. The power supply module is electrically connected to the atomizing core 100 for supplying power to the heating member 10 of the atomizing core 100.

Specifically, the power supply module may be electrically connected to the atomizing core 100 through the pin 2.

In some embodiments, the power supply module includes a battery and a charging interface that are electrically connected. The atomizing device further includes a control circuit.

When the atomizing device is in operation, the power supply module delivers electrical energy of a certain power to the heating member 10 of the atomizing core 100 under the control of the control circuit. The heating member 10 generates heat, which acts on the first liquid-guiding element 20 to generate aerosol. The user may cause the aerosol to be discharged from the atomizing device through the atomizing channel by inhaling from a mouthpiece that is in communication with the atomizing channel.

In some embodiments, the atomizing device further includes a liquid storage structure for storing the aerosol-generating matrix. The atomizing core 100 communicates with the liquid storage structure, enabling the aerosol-generating matrix in the liquid storage structure to flow to the first liquid-guiding element 20 through the second liquid-guiding element 40.

Specifically, the liquid storage structure may be configured to include a liquid-absorbing assembly capable of adsorbing a certain amount of aerosol-generating matrix, and this liquid-absorbing assembly may be liquid-absorbing cotton. The aerosol-generating matrix is adsorbed in the liquid-absorbing assembly, which can better prevent leakage of the aerosol-generating matrix. The atomizing core 100 may pass through the middle of the liquid-absorbing assembly.

Of course, the liquid storage structure may also include other housing-like structures, etc. It should be understood by those skilled in the art that the assembly structure and shape of each member in the atomizing device can refer to existing structures in the related art, which will not be described in detail herein.

It can be understood that the atomizing device provided by the embodiments of the present disclosure includes the beneficial effects of any one or more of the atomizing cores 100 described above, and will not be repeated here. The above descriptions of the various embodiments above tend to emphasize the differences between the embodiments, and for their same or similar parts, reference may be made to each other. For the sake of conciseness, they will not be repeated here.

The above descriptions are merely preferred embodiments of the present disclosure, and are not intended to limit the present disclosure. Any modifications, equivalent substitutions, improvements, etc. made within the spirit and principles of the present disclosure shall be included in the protection scope of the present disclosure.

What is claimed is:

1. A atomizing core, comprising:
a heating member comprising a heating portion, wherein the heating portion comprises a first heating element, a first connecting element, and a second heating element connected sequentially, and the first heating element and the second heating element are disposed opposite to each other and spaced apart; and
a first liquid-guiding element disposed between the first heating element and the second heating element, configured to adsorb and transport aerosol-generating matrix.

2. The atomizing core of claim 1, wherein a resistance value of the first heating element is different from a resistance value of the second heating element.

3. The atomizing core of claim 2, wherein the resistance value of the first heating element is less than the resistance value of the second heating element.

4. The atomizing core of claim 1, wherein an orthographic projection area of the first heating element is less than an orthographic projection area of the second heating element in a thickness direction of the heating portion.

5. The atomizing core of claim 1, wherein an end of the first heating element close to the first connecting element is defined as a first end, and an end of the first heating element facing away from the first connecting element is defined as a second end; and an end of the second heating element close to the first connecting element is defined as a third end, and an end of the second heating element facing away from the first connecting element is defined as a fourth end; and
wherein a distance between the first end and the second end is less than a distance between the third end and the fourth end.

6. The atomizing core of claim 1, wherein the heating portion further comprises a second connecting element, wherein the second connecting element is disposed at an end of the first heating element facing away from the first connecting element, or disposed at an end of the second heating element facing away from the first connecting element; or
wherein the heating portion further comprises two second connecting elements, one of the two second connecting elements is disposed at an end of the first heating element facing away from the first connecting element, and another of the two second connecting elements is disposed at an end of the second heating element facing away from the first connecting element.

7. The atomizing core of claim 6, wherein the heating portion is a tubular structure, and the second connecting element is disposed close to and spaced apart from the first connecting element; and
wherein the first heating element is located inside the second heating element in a radial direction of the tubular structure, and the second connecting element and the first connecting element are respectively located at both ends of the tubular structure in a circumferential direction of the tubular structure.

8. The atomizing core of claim 7, wherein the heating member further comprises a first conductive pin and a second conductive pin, the first conductive pin is connected to the second connecting element, and the second conductive pin is connected to the first connecting element.

9. The atomizing core of claim 8, wherein both the first conductive pin and the second conductive pin extend in an axial direction of the tubular structure.

10. The atomizing core of claim 7, further comprising a fixing element, wherein the fixing element is mounted on an end of the tubular structure in an axial direction of the tubular structure.

11. The atomizing core of claim 10, wherein the fixing element comprises a C-shaped structure and/or an O-shaped structure.

12. The atomizing core of claim 1, further comprising an atomizing bracket, wherein the atomizing bracket is a hollow columnar structure, the heating member is bent and disposed on an inner sidewall of the atomizing bracket, and a gap is defined between an outer sidewall of the heating member and an inner sidewall of the atomizing bracket.

13. The atomizing core of claim 12, further comprising a second liquid-guiding element, wherein the second liquid-guiding element at least partially fills the gap.

14. The atomizing core of claim 1, further comprising at least two second liquid-guiding elements, wherein the at least two second liquid-guiding elements, the second heating element, the first liquid-guiding element, and the first heating element are sequentially stacked, and the at least two second liquid-guiding elements are configured to transport the aerosol-generating matrix to the first liquid-guiding element; wherein liquid-guiding rates of the at least two second liquid-guiding elements increase sequentially in a transportation direction of the aerosol-generating matrix, and the liquid-guiding rates of the at least two second liquid-guiding elements are greater than a liquid-guiding rate of the first liquid-guiding element.

15. The atomizing core of claim 14, wherein porosities of the at least two second liquid-guiding elements increase sequentially in the transportation direction of the aerosol-generating matrix, and the porosities of the at least two second liquid-guiding elements are greater than a porosity of the first liquid-guiding element.

16. The atomizing core of claim 14, further comprising an atomizing bracket, wherein the heating member is disposed on an inner sidewall of the atomizing bracket, and an inner sidewall of the atomizing bracket is in contact with an outer sidewall of an outermost one of the at least two second liquid-guiding elements.

17. The atomizing core of claim 16, wherein the inner sidewall of the atomizing bracket is provided with a positioning strip extending in a vertical direction, and both ends of the heating member abut against a sidewall of the positioning strip.

18. The atomizing core of claim 14, wherein both the first liquid-guiding element and the at least two second liquid-guiding elements are liquid-guiding cotton, and a heating temperature of the first heating element is lower than a heating temperature of the second heating element.

19. An atomizing assembly comprising an atomizing core and a base disposed at a bottom of the atomizing core, wherein the atomizing core comprises:
a heating member comprising a heating portion, wherein the heating portion comprises a first heating element, a first connecting element, and a second heating element connected sequentially, and the first heating element and the second heating element are disposed opposite to each other and spaced apart; and
a first liquid-guiding element disposed between the first heating element and the second heating element, configured to adsorb and transport aerosol-generating matrix.

20. An atomizing device comprising an atomizing core and a power supply module electrically connected to the atomizing core, wherein the atomizing core comprises:
a heating member comprising a heating portion, wherein the heating portion comprises a first heating element, a first connecting element, and a second heating element connected sequentially, and the first heating element and the second heating element are disposed opposite to each other and spaced apart; and
a first liquid-guiding element disposed between the first heating element and the second heating element, configured to adsorb and transport aerosol-generating matrix.
